(19) United States
(12) Patent Application Publication
(10) Pub. No.: US 2010/0301286 A1
(43) Pub. Date: Dec. 2, 2010

(54) FLAME RETARDED THERMOSETS

(75) Inventors: Thomas Dittmar, Koln (DE); Hans Peter Hillekamps, Erkelenz-Immerath (DE); Jens Pfeiffer, Bergheim (DE)

Correspondence Address: ALBEMARLE CORPORATION;PATENT DEPARTMENT, 451 FLORIDA STREET, BATON ROUGE, LA, 70801, US

(73) Assignee: Martinswerk GMBH, Bergheim (DE)

(21) Appl. No.: 12/599,461

(22) PCT Filed: May 7, 2008
(86) PCT No.: PCT/EP08/03677

§ 371 Date: Nov. 9, 2009

Related U.S. Application Data
(60) Provisional application No. 60/916,473, filed on May 7, 2007.

(51) Int. Cl. C09K 21/12; C08K 5/5317; C08F 2/46; C08J 9/04

(52) U.S. Cl. 252/602; 524/130; 522/76; 521/182

(57) ABSTRACT

The present invention relates to flame retarded thermoset formulations with good viscosity performance.

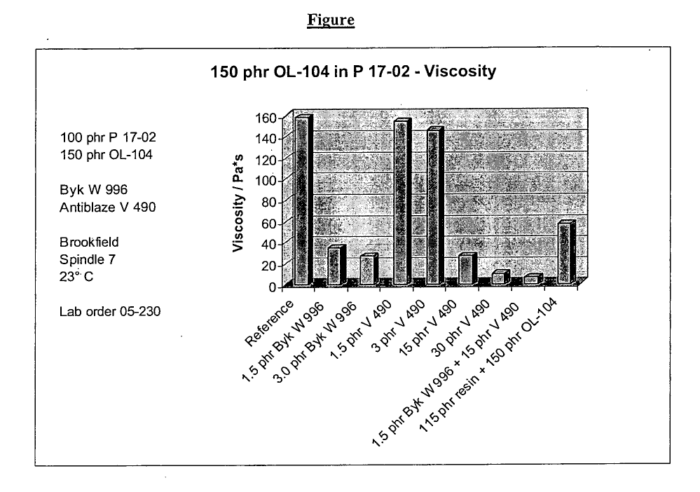

### FIELD OF THE INVENTION

The present invention relates to flame retarded thermoset formulations with good viscosity performance.

### BACKGROUND OF THE INVENTION

Thermoset resins such as, for example, those derived from polyester resins, are used in many applications today. Because of their widespread use, much research has been done on providing flame retardancy to thermoset resins. To this end, mineral flame retardants such as metal hydroxides have been used to provide flame retardant properties to thermoset resins. However, in order to achieve the desired level of flame retardancy, large loadings of metal hydroxides are necessary. While these high loading levels typically provide adequate flame retardancy, the high loading of metal hydroxide make the theremoset resin very viscous, which is detrimental to processes like hand lamination, pultrusion, RTM and the like, which are commonly used. In the past, wetting additives such as those sold under the BYK line of products from BYK Chemie have been used to reduce the viscosity of the metal hydroxide-containing thermoset resin. However, the use of these additives, while effective at reducing the viscosity of the metal hydroxide-containing thermoset resin, is quite often detrimental to the flame retardancy of the thermoset resin.

### BRIEF DESCRIPTION OF THE FIGURE

The FIGURE is a graph depicting the viscosity of various flame retarded thermoset formulations, some of the present invention, some not, which were produced and analyzed in the Examples section of the present application.

### SUMMARY OF THE INVENTION

The present invention relates to a flame retarded thermoset derivable from: a) at least one, in some embodiments only one, phosphonate, in some embodiments diethyl ethylphosphonate; b) at least one, in some embodiments only one, metal hydroxide; c) at least one thermoset resin; and, optionally, one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

In another embodiment, the present invention relates to a flame retardant additive suitable for use in thermoset resins comprising: a) at least one, in some embodiments only one, phosphonate, in some embodiments diethyl ethylphosphonate; and b) at least one, in some embodiments only one, metal hydroxide.

The present invention relates to a flame retarded thermoset formulation comprising: a) at least one, in some embodiments only one, phosphonate, in some embodiments diethyl ethylphosphonate; b) at least one, in some embodiments only one, metal hydroxide; c) at least one thermoset resin; and one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

In another embodiment, the present invention also relates to a process for forming a flame retarded thermoset comprising combining a) at least one, in some embodiments only one, phosphonate, in some embodiments diethyl ethylphosphonate; b) at least one, in some embodiments only one, metal hydroxide; c) at least one thermoset resin; and one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing promoters; photoinitiators; blowing agents, rhelogical modifiers; impact modifiers; mold release aids; nucleating agents; the like, and combinations thereof, in the presence of at least one, in some embodiments only one, curing catalyst.

The present invention also relates to articles formed from the flame retarded thermoses formulations.

### DETAILED DESCRIPTION OF THE INVENTION

### Thermoset Resins

Thermosetting or thermoset resins useful in the present invention include acrylics, urethanes, unsaturated polyesters, vinyl esters, epoxies, phenol/formaldehyde resins, urea/formaldehyde resins and melamine/formaldehyde resins; crosslinkable acrylic resins derived from substituted acrylates such as epoxy acrylates, hydroxy acrylates, isocyanato acrylates, urethane acrylates or polyester acrylates; alkyd resins, polyester resins and acrylate resins crosslinked with melamine resins, urea resins, isocyanates, isocyanurates, carbamates, epoxy resins, functionalized poly(arylene ether) resins, which may be a capped poly(arylene ether) or ring-functionalized poly(arylene ether); unsaturated polyester resins, urea resins; and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (latices). In some embodiments, the thermoset resin is an unsaturated polyester resin.

Suitable unsaturated polyester resins include practically any esterification product of a polybasic organic acid or anhydride and a polyhydric alcohol, wherein either the acid or the alcohol, or both, provide the reactive ethylenic unsaturation. Typical unsaturated polyesters are those thermosetting resins made from the esterification of a polyhydric alcohol with an ethylenically unsaturated polycarboxylic acid. Examples of useful ethylenically unsaturated polycarboxylic acids include maleic acid, fumaric acid, itaconic acid, dihydromuconic acid and halo and alkyl derivatives of such acids and anhydrides, and mixtures thereof. Exemplary polyhydric alcohols include saturated polyhydric alcohols such as ethylene glycol, 1,3-propanediol, propylene glycol, 1,3-butanediol, 1,4-butanediol, 2-ethylbutane-1,4-diol, octanediol, 1,4-cyclohexanediol, 1,4-dimethylolcyclohexane, 2,2-diethylpropane-1,3-di- ol, 2,2-diethylbutane-1,3-diol, 3-methylpentane-1,4-diol, 2,2-dimethylpropane-1,3-diol, 4,5-nonanediol, diethylene glycol, triethylene glycol, dipropylene glycol, glycerol, pentaerythritol, erythritol, sorbitol, mannitol, 1,1,1 -trimethylolpropane, trimethylolethane, hydrogenated bisphenol-A and the reaction products of bisphenol-A with ethylene or propylene oxide.

Unsaturated polyester resins can also be derived from the esterification of saturated polycarboxylic acid or anhydride with an unsaturated polyhydric alcohol. Exemplary saturated polycarboxylic acids include oxalic acid, malonic acid, succinic acid, methylsuccinic acid, 2,2-dimethylsuccinic acid, 2,3-dimethylsuccinic acid, hydroxylsuccinic acid, glutaric acid, 2-methylglutaric acid, 3-methylglutaric acid, 2,2-dimethylglutaric acid, 3,3-dimethylglutaric acid, 3,3-diethylglutaric acid, adipic acid, pimelic acid, suberic acid, azelaic acid, sebacic acid, phthalic acid, isophthalic acid, terephthalic acid, tetrachlorophthalic acid, tetrabromophthalic acid, tetrahydrophthalic acid, 1,2-hexahydrophthalic acid, 1,3-hexahydrophthalic acid, 1,4-hexahydrophthalic acid, 1,1-cyclobutanedicarboxylic acid and trans-1,4-cyclohexanedicarboxylic acid.

Unsaturated polyhydric alcohols which are suitable for reacting with the saturated polycarboxylic acids include ethylenic unsaturation-containing analogs of the above saturated alcohols (e.g., 2-butene-1,4-diol).

The resin used herein can be formed by the addition of recycled polyethylene terephthalate (PET), such as from soda bottles to the base resin prior to polymerization. PET bottles can be ground and depolymerized in the presence of a glycol, which produces an oligomer. The oligomer can then be added to a polymerization mixture containing polyester monomer and polymerized with such monomer to an unsaturated polyester.

Suitable vinyl ester resins include practically any reaction product of an unsaturated polycarboxylic acid or anhydride with an epoxy resin. Exemplary acids and anhydrides include (meth)acrylic acid or anhydride, a-phenylacrylic acid, a-chloroacrylic acid, crotonic acid, mono-methyl and mono-ethyl esters of maleic acid or fumaric acid, vinyl acetic acid, cinnamic acid, and the like. Epoxy resins which are useful in the preparation of the polyvinyl ester are well known and commercially available. Exemplary epoxies include virtually any reaction product of a polyfunctional halohydrin, such as epichlorohydrin, with a phenol or polyhydric phenol. Suitable phenols or polyhydric phenols include for example, resorcinol, tetraphenol ethane, and various bisphenols such as bisphenol-A, 4,4′-dihydroxydiphenyl-sulfone, 4,4′-dihydroxy biphenyl, 4,4′-dihydroxydi-phenylmethane, 2,2′-dihydroxydiphenyloxide, and the like.

Typically, the unsaturated polyester or vinyl ester resin material also includes a vinyl monomer in which the thermosetting resin is solubilized. Suitable vinyl monomers include styrene, vinyl toluene, methyl methacrylate, p-methyl styrene, divinyl benzene, diallyl phthalate and the like. Styrene is the preferred vinyl monomer for solubilizing unsaturated polyester or vinyl ester resins.

Suitable phenolic resins include practically any reaction product of an aromatic alcohol with an aldehyde. Exemplary aromatic alcohols include phenol, orthocresol, metacresol, paracresol, Bisphenol A, p-phenylphenol, p-tert-butylphenol, p-tert-amylphenol, p-tert-octylphenol and p-nonylphenol. Exemplary aldehydes include formaldehyde, acetaldehyde, propionaldehyde, phenylacetaldehyde, and benzaldehyde. Particularly preferred are the phenolic resins prepared by the reaction of phenol with formaldehyde.

The resin may comprise an epoxy resin, i.e., one that contains at least one oxirane group in the molecule. Hydroxyl substituent groups can also be present and frequently are, as well as ether groups. Halogen substituents may also be present. Generally, the epoxy resins can be broadly categorized as being aliphatic, aromatic, cyclic, acyclic, alicylic or heterocyclic. In some embodiments, aromatic epoxide resins are used. One group of aromatic epoxy resins are the polyglycidyl ethers of polyhydric aromatic alcohols, such as, for example, dihydric phenols. Suitable examples of dihydric phenols include resorcinol, catechol, hydroquinone, bis(4-hydroxyphenyl)-1, 1-isobutane; 4,4-dihydroxybenzophenone; bis(4-hydroxyphenyl)-1,1-ethane; bis(2-hydroxynaphenyl)methane; 1,5-hydroxynaphthalene and 4,4′-isopropylidenediphenol, i.e., bisphenol A. Of the many epoxy compounds that may be utilized to synthesize the epoxy resins, the one principally utilized is epichlorohydrin, although epibromohydrin is also useful. The polyglycidyl ethers are obtained by reacting epichlorohydrin and bisphenol A in the presence of an alkali such as sodium or potassium hydroxide. The series of epoxy resins sold by Shell Chemical Company under the trademark EPON are useful. Another group of useful epoxy resins are the polyglycidyl ethers derived from such polyhydric alcohols as ethylene glycol; diethylene glycol; triethylene glycol; 1,2-propylene glycol; 1,4-butylene glycol; 1,5-pentanediol; 1,2,6-hexanetriol; glycerol and trimethylolpropane. Also useful are the epoxide resins that are polyglycidyl ethers of polycarboxylic acids. These materials are produced by the reaction of an epoxy compound such as epichlorohydrin with an aliphatic or aromatic polycarboxylic acid such as oxalic acid; succinic acid; glutaric acid; terephthalic acid; 2,6-napthalene dicarboxylic acid and dimerized linoleic acid. Still another group of epoxide resins are derived from the epoxidation of an olefinically unsaturated alicyclic material. Among these are the epoxy alicyclic ethers and esters well known in the art.

Epoxy resins also include those containing oxyalkylene groups. Such groups can be pendant from the backbone of the epoxide resin or they can be included as part of the backbone. The proportion of oxyalkylene groups in the epoxy resin depends upon a number of factors, such as the size of the oxyalkylene group and the nature of the epoxy resin.

One additional class of epoxy resins encompasses the epoxy novolac resins. These resins are prepared by reacting an epihalohydrin with the condensation product of an aldehyde with a monohydric or polyhydric phenol. One example is the reaction product of epichlorohydrin with a phenolformaldehyde condensate. A mixture of epoxy resins can also be used herein.

The epoxy resins require the addition of a curing agent in order to convert them to thermoset materials. In general, the curing agents which can be utilized herein can be selected from a variety of conventionally known materials, for example, amine type, including aliphatic and aromatic amines, and poly(amine-amides). Examples of these include diethylene triamine; 3,3-amino bis propylamine; triethylene tetraamine; tetraethylene pentamine; m-xylylenediamine; and the reaction product of an amine and an aliphatic fatty acid such as the series of materials sold by Henkel Corporation under the name VERSAMID.

Also suitable as curing agents for epoxies are polycarboxylic acids and polycarboxylic acid anhydrides. Examples of polycarboxylic acids include di-, tri-, and higher carboxylic acids such as, for example, oxalic acid, phthalic acid, terephthalic acid, succinic acid, alkyl and alkenyl-substituted succinic acids, tartaric acid, and polymerized fatty acids. Examples of suitable polycarboxylic acid anhydrides include, among others, pyromellitic anhydride, trimellitic anhydride, phthalic anhydride, succinic anhydride, and maleic anhydride. In addition, aldehyde condensation products such as urea-, melamine-, or phenol-formaldehyde are useful curing agents. Other suitable curing agents include boron trihalide and complexes of boron trihalide with amines, ethers, phenols and the like; polymercaptans; polyphenols; metal salts such as aluminum chloride, zinc chloride and magnesium perchlorate; inorganic acids and partial esters such as phosphoric acid and n-butyl orthophosphite. It should be understood that blocked or latent curing agents can also be utilized if desired; for example, ketimines that are prepared from a polyamine and a ketone.

The amount of the epoxy resin and curing agent utilized can vary, but generally the equivalent ratio of epoxy to amine is within the range of from 0.05:1 to 10:1. Preferably, the epoxy to amine equivalent ratio is within the range of from 0.1:1 to 1:1, and more preferably within the range of 0.3:1 to 0.9: 1.

In the case of capped poly(arylene ether), there is no particular limitation on the method by which these are prepared. For example, the capped poly(arylene ether) may be formed by the reaction of an uncapped poly(arylene ether) with a capping agent. Capping agents include compounds known in the literature to react with phenolic groups. Such compounds include both monomers and polymers containing, for example, anhydride, acid chloride, epoxy, carbonate, ester, isocyanate, cyanate ester, or alkyl halide radicals. Capping agents are not limited to organic compounds as, for example, phosphorus and sulfur based capping agents also are included. Examples of capping agents include, for example, acetic anhydride, succinic anhydride, maleic anhydride, salicylic anhydride, polyesters comprising salicylate units, homopolyesters of salicylic acid, acrylic anhydride, methacrylic anhydride, glycidyl acrylate, glycidyl methacrylate, acetyl chloride, benzoyl chloride, diphenyl carbonates such as di(4-nitrophenyl) carbonate, acryloyl esters, methacryloyl esters, acetyl esters, phenylisocyanate, 3 -isopropenyl-alpha, alpha-dimethylphenylisocyanate, cyanatobenzene, 2,2-bis(4-cyanatophenyl)propane), 3-(alpha-chloromethyl)styrene, 4-(alpha-chloromethyl) styrene, allyl bromide, and the like, carbonate and substituted derivatives thereof, and mixtures thereof. These and other methods of forming capped poly(arylene ether)s are described, for example, in U.S. Pat. No. 3,375,228 to Holoch et al.; U.S. Pat. No. 4,148,843 to Goossens; U.S. Pat. Nos. 4,562,243, 4,663,402, 4,665,137, and 5,091,480 to Percec et al.; U.S. Pat. Nos. 5,071,922, 5,079,268, 5,304,600, and 5,310,820 to Nelissen et al.; U.S. Pat. No. 5,333,796 to Vianello et al.; and European Patent No. 261,574 B1 to Peters et al.

In one embodiment, the capped poly(arylene ether) may be prepared by reaction of an uncapped poly(arylene ether) with an anhydride in an alkenyl aromatic monomer as solvent. This approach has the advantage of generating the capped poly (arylene ether) in a form that can be immediately blended with other components to form a curable composition; using this method, no isolation of the capped poly (arylene ether) or removal of unwanted solvents or reagents is required.

A capping catalyst may be employed in the reaction of an uncapped poly(arylene ether) with an anhydride. Examples of such compounds include those known to the art that are capable of catalyzing condensation of phenols with the capping agents described above. Useful materials are basic compounds including, for example, basic compound hydroxide salts such as sodium hydroxide, potassium hydroxide, tetraalkylammonium hydroxides, and the like; tertiary alkylamines such as tributyl amine, triethylamine, dimethylbenzylamine, dimethylbutylamine and the like; tertiary mixed alkyl-arylamines and substituted derivatives thereof such as N,N-dimethylaniline; heterocyclic amines such as imidazoles, pyridines, and substituted derivatives thereof such as 2-methylimidazole, 2-vinylimidazole, 4-(dimethylamino) pyridine, 4-(1-pyrrolino)pyridine, 4-(1-piperidino)pyridine, 2-vinylpyridine, 3-vinylpyridine, 4-vinylpyridine, and the like. Also useful are organometallic salts such as, for example, tin and zinc salts known to catalyze the condensation of, for example, isocyanates or cyanate esters with phenols. The organometallic salts useful in this regard are known to the art in numerous publications and patents well known to those skilled in this art.

### Additives

The compositions of the present invention may, optionally, further comprise one or more additives known in the art, such as, for example, dyes; pigments; colorants; antioxidants; stabilizers such as, for example, heat stabilizers or light stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

The proportions of the optional additives are conventional and can be varied to suit the needs of any given situation, all of which are within the knowledge of one having ordinary skill in the art.

Individual additives, i.e., UV light stabilizer, may be emulsified, added to resin dispersions and co-spray-dried. Alternatively, emulsified additives, such as pigment dispersions may be added directly to resin powders in a suitable mixing device that allows for the addition of heat and the removal of water. Likewise, PVC wetcake may also be blended with powder or aqueous-based nanoparticle dispersions. Numerous combinations of mixing emulsion-based additives and powders followed by subsequent drying may be envisioned by one skilled in the art.

Suitable multivalent metal ions include those in Groups HA, IIIA, and IB-VIIIB of the periodic table. The multivalent metal ions may be present, for example, as salts of counterions including halides, hydroxides, oxides and the like.

Curing catalysts, also referred to as initiators, are well known to the art and used to initiate the polymerization, cure or crosslink any of numerous thermosets including, but not limited to, unsaturated polyester, vinyl ester and allylic thermosets. Non-limiting examples of curing catalysts are those described in “Plastic Additives Handbook, 4 Edition” R. Gachter and H. Muller (eds.), P. P. Klemchuck (assoc. ed.) Hansen Publishers, New York 1993, and in U.S. Pat. No. 5,407,972 to Smith et al., and U.S. Pat. No. 5,218,030 to Katayose et al.

Curing promoters, used to decrease the gel time, are also well-known in the art and any suitable curing promoter can be used herein. Non-limiitng examples of suitable curing promoters include transition metal salts and complexes such as cobalt naphthanate; and organic bases such as N,N-dimethylaniline (DMA) and N,N-diethylaniline (DEA).

Non-limiting examples of photoinitiators are those described in U.S. Pat. No. 5,407,972, including, for example, ethyl benzoin ether, isopropyl benzoinether, butyl benzoin ether, isobutyl benzoin ether, alpha,alpha-diethoxyacetophenone, alpha,alpha-dimethoxy-alpha-phenylacetophenone, diethoxyphenylacetophenone, 4,4′-dicarboethoxybenzoin ethylether, benzoin phenyl ether, alpha-methylbenzoin ethyl ether alpha-methylolbenzoin methyl ether, trichloroacetophenone, and the like, and mixtures comprising at least one of the foregoing photoinitiators.

Non-limiting examples of lubricants include fatty alcohols and their dicarboxylic acid esters including cetyl, stearyl and tall oil alcohol, distearyl adipate, distearyl phthalate, fatty acid esters of glycerol and other short chain alcohols including glycerol monooleate, glycerol monostearate, glycerol 12-hydroxystearate, glycerol tristearate, trimethylol propane tristearate, pentaerythritol tetrastearate, butyl stearate, isobutyl stearate, stearic acids, 12-hydroxystearic acid, oleic acid amide, erucamide, bis(stearoyl)ethylene diamine, calcium stearate, zinc stearate, neutral lead stearate, dibasic lead stearate, stearic acid complex esters, oleic acid complex esters, calcium soap containing complex esters, fatty alcohol fatty acid esters including isotridecyl stearate, cetyl palmitate, stearyl stearate, behenyl behenate, montanic acid, montanic acid ethylene glycol esters, montanic acid glycerol esters, montanic acid pentaerythritol esters, calcium soap containing montanic acid esters, calcium montanate, sodium montanate; linear or branched polyethylene, partially saponified polyethylene wax, ethylene-vinyl acetate copolymer, crystalline polyethylene wax; natural or synthetic paraffin including fully refined wax, hardened paraffin wax, synthetic paraffin wax, microwax, and liquid paraffin; fluoropolymers including polytetrafluoroethylene wax, and copolymers with vinylidene fluoride.

Non-limiting examples of suitable conductive agents include graphite, conductive carbon black, conductive carbon fibers, metal fibers, metal particles, particles of intrinsically conductive polymers, and the like. Suitable conductive carbon fibers include those having a length of about 0.25 inch and a diameter of about 7 micrometers. Suitable conductive carbon fibers also include agglomerates of fibers having an aspect ratio of at least 5 and an average diameter of about 3.5 to about 500 nanometers as described, for example, in U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al. Suitable graphite particles may have an average particle size of about 20 to about 1,000 nanometers and a surface area of about 1 to about 100 m²/g. Examples of suitable carbon blacks include particles of carbon having an average primary particle diameter of less than about 125 nanometers, more preferably less than about 60 nanometers. The carbon black is preferably utilized as an aggregate or agglomerate of primary particles, the aggregate or agglomerate typically having a size about 5 to about 10 times the primary particle size. Larger agglomerates, beads, or pellets of carbon particles may also be utilized as a starting material in the preparation of the composition, so long as they disperse during the preparation or processing of the composition sufficiently to reach an average size in the cured composition of less than about 10 microns, more preferably less than about 5 microns, and more preferably less than about 1.25 microns. Suitable intrinsically conductive polymers include polyanilines, polypyrroles, polyphenylene, polyacetylenes, and the like.

Examples of fillers are well known to the art include those described in “Plastic Additives Handbook, 4^{th} Edition” R. Gachter and H. Muller (eds.), P. P. Klemchuck (assoc. ed.) Hansen Publishers, New York 1993. Non-limiting examples of fillers include silica powder, such as fused silica and crystalline silica; boron-nitride powder and boron-silicate powders for obtaining cured products having low dielectric constant and low dielectric loss tangent; the above-mentioned powder as well as alumina, and magnesium oxide (or magnesia) for high temperature conductivity; and fillers, such as wollastonite including surface-treated wollastonite, calcium sulfate (as its anhydride, dihydrate or trihydrate), calcium carbonate including chalk, limestone, marble and synthetic, precipitated calcium carbonates, generally in the form of a ground particulate which often comprises 98+% CaCO₃ with the remainder being other inorganics such as magnesium carbonate, iron oxide, and alumino-silicates; surface-treated calcium carbonates; talc, including fibrous, modular, needle shaped, and lamellar talc; glass spheres, both hollow and solid, and surface-treated glass spheres typically having coupling agents such as silane coupling agents and/or containing a conductive coating; and kaolin, including hard, soft, calcined kaolin, and kaolin comprising various coatings known to the art to facilitate the dispersion in and compatibility with the chosen thermoset resin; mica, including metallized mica and mica surface treated with aminosilanes or acryloylsilanes coatings to impart good physicals to compounded blends; feldspar and nepheline syenite; silicate spheres; flue dust; cenospheres; finite; aluminosilicate (armospheres), including silanized and metallized aluminosilicate; natural silica sand; quartz; quartzite; perlite; Tripoli; diatomaceous earth; synthetic silica, including those with various silane coatings, and the like.

Non-limiting examples of fibrous fillers include short inorganic fibers, including processed mineral fibers such as those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, carbon, iron, nickel, copper. Also included among fibrous fillers are glass fibers, including textile glass fibers such as E, A, C, ECR, R, S, D, and NE glasses and quartz. Preferred fibrous fillers include glass fibers having a diameter of about 5 to about 25 micrometers and a length before compounding of about 0.5 to about 4 centimeters. Many other suitable fillers are described in U.S. patent application Publication No. 2001/0053820 A1 to Yeager et al.

Non-limiting examples of suitable adhesion promoters, used to improve adhesion of the thermosetting resin to the filler or to an external coating or substrate, include chromium complexes, silanes, titanates, zirco-aluminates, propylene maleic anhydride copolymers, reactive cellulose esters and the like. Non-limiting examples of some more common adhesion promoters include vinyl-triethoxysilane, vinyl tris(2-methoxy)silane, .gamma.-methacryloxypropyltrimethoxy silane, .gamma.-aminopropyltriethoxysilane, .gamma.-glycidoxypropyltrimethoxysilane, and .gamma.-mercaptopropyltrimethoxysilane. The adhesion promoter may be included in the thermosetting resin itself, or coated onto any of the fillers described above to improve adhesion between the filler and the thermosetting resin. For example such promoters may be used to coat a silicate fiber or filler to improve adhesion of the resin matrix.

In some embodiments, the filler is calcium carbonate. In another embodiment, the filler is glass fibers. In another embodiment, the filler comprises both calcium carbonate and glass fibers.

The fillers may be added to the thermosetting resin without any treatment, or after surface treatment, generally with an adhesion promoter.

### Phosphonates

Phosphonates suitable for use herein can be selected from any phosphonate known in the art to be effective at providing some flame retardant properties to thermoset resins. Non-limiting examples of suitable phosphonates include diethyl ethylphosphonates, dimethyl methylphosphonates, dimethyl propylphosphonates, the like, etc. Non-limiting examples of diethyl ethylphosphonates suitable for use herein can be any known in the art. In preferred embodiments, the diethyl ethylphosphonates are those marketed by the Albemarle® Corporation under the name Antiblaze®, preferably Antiblaze® V490. The amount of phophonate typically present in the flame retardant additive is in the range of from about 0.1 to about 25 wt. %, preferably in the range of from about 5 to about 20 wt. %, more preferably in the range of from about 7 to about 15 wt. %, all based on the total weight of the flame retardant additive.

### Metal Hydroxides

The flame retardant additives of the present invention comprise at least one, in some embodiments only one, metal hydroxide. Metal hydroxides suitable for use herein can be any known in the art having a d50 in the range of from about 0.1 to about 30, preferably in the range of from about 2 to about 12, more preferably in the range of from about 3 to about 9. The metal hydroxide can be either magnesium hydroxide or aluminum hydroxide, preferably aluminum hydroxide. In preferred embodiments, the metal hydroxides are those marketed by the Albemarle® Corporation under the name Martinal® or Magnifin®, preferably the Martinal® ON series, in some embodiments, Martinal® ON-906. The amount of metal hydroxide typically present in the flame retardant additive is in the range of from about 75 to about 99.99 wt. %, all based on the total weight of the flame retardant additive.

The flame retardant additive of this invention can be employed in an effective amount in any known procedure for thermoset resin formulations. In these embodiments, the amount of metal hydroxide used is in the range of from about 40 to about 85 wt. %, based on the total weight of the thermoset resin formulation.

By an effective amount of the flame retardant additive, it is meant that amount sufficient to meet or exceed the test standards set forth in UL 94 vertical flammability test. Generally, this is in the range of from about 80 to about 500 phr, sometimes in the range of from about 100 to about 300 phr, of the flame retardant additive. In preferred embodiments, an effective amount is to be considered in the range of from about 150 to about 200 phr.

The flame retardant additive of the present invention also provides for flame retarded thermoset resin formulations having good viscosity performances. By good viscosity performances, it is meant that the flame retarded thermoset resin formulations containing an effective amount of the flame retardant additive have a viscosity, as determined by using a Brookfield viscometer at a temperature of 23° C., in the range of from about 1 to about 150 Pa*s, preferably in the range of from about 1.5 to about 50 Pa*s, more preferably in the range of from about 2 to about 20 Pa*s.

### Preparation of Flame Retarded Thermoset Formulations

There is no particular limitation on the method by which the flame retarded thermoset formulations of the present invention are prepared. For example, the flame retarded thermoset formulations may be prepared by forming an intimate blend comprising the thermoset resin, flame retardant additive, and optional components, if so used. When the composition comprises an alkenyl aromatic monomer and the poly(arylene ether) is a capped poly(arylene ether), the composition may be prepared directly from an unfunctionalized poly(arylene ether) by dissolving the uncapped poly(arylene ether) in a portion of the alkenyl aromatic monomer, adding a capping agent form the capped poly(arylene ether) in the presence of the alkenyl aromatic monomer, and adding the fused alicyclic(meth)acrylate monomer and any other components to form the thermoset composition.

There is also no particular limitation on the method or apparatus used to blend the components of the flam retarded thermoset formulations. Suitable internal blending methods include dough mixing, Banbury mixing, helicone mixing, Henschel mixing, plow mixing, agitated vessel mixing, and the like, and combinations comprising at least one of the foregoing methods, which are known to those skilled in the art. Preferred blending methods include dough mixing, Henschel mixing, and the like, and combinations comprising at least one of the foregoing methods.

### Curing of Thermoset Formulations

There is no particular limitation on the method by which the flame retarded thermoset formulations may be cured. The composition may, for example, be cured thermally or by using irradiation techniques, including, for example, UV irradiation and electron beam irradiation. When heat curing is used, the temperature selected may be in the range of from about 80° C. to about 300° C. Within this range, a temperature of up to about 120° C. may be used, sometimes a temperature up to about 240° C. The heating period may be about 30 seconds to about 24 hours. Within this range, it may be preferred to use a heating time of at least about 1 minute, sometimes at least about 2 minutes. In some embodiments, a heating time up to about 10 hours, sometimes up to about 5 hours, sometimes up to about 3 hours, may be used. Such curing may be staged to produce a partially cured and often tack-free resin, which then is fully cured by heating for longer periods or temperatures within the aforementioned ranges.

In one embodiment, the present invention is a cured composition obtained by curing any of the thermoset formulations of the present invention. Because the components of the curable composition may react with each other during curing, the cured composition may be described as comprising the reaction product obtained or obtainable by curing the flame retarded thermoset formulations of the present invention. Thus, one embodiment is a cured composition, comprising the reaction product obtained or obtainable by curing flame retarded thermoset formulations of the present invention. It will be understood that the terms “curing” and “cured” include partial curing to form, for example, so-called B-stage compositions. Another embodiment is a cured composition, comprising the reaction product of: a methacrylate-capped poly(arylene ether); and a fused alicyclic(meth)acrylate monomer.

### Articles

Another embodiment is an article made or produced from any of the flame retarded thermoset formulations of the present invention. The flame retarded thermoset formulations of the present invention are useful for fabricating a wide range of articles. Articles that may be fabricated from the flame retarded thermoset formulations of the present invention include, for example, acid bath containers, neutralization tanks, electrorefining tanks, water softener tanks, fuel tanks, filament-wound tanks, filament-wound tank linings, electrolytic cells, exhaust stacks, scrubbers, automotive exterior panels, automotive floor pans, automotive air scoops, truck bed liners, drive shafts, drive shaft couplings, tractor parts, transverse leaf springs, crankcase heaters, heat shields, railroad tank cars, hopper car covers, boat hulls, submarine hulls, boat decks, marine terminal fenders, aircraft components, propeller blades, missile components, rocket motor cases, wing sections, sucker rods, fuselage sections, wing skins, wing flairings, engine narcelles, cargo doors, aircraft stretch block and hammer forms, bridge beams, bridge deckings, stair cases, railings, walkways, pipes, ducts, fan housings, tiles, building panels, scrubbing towers, flooring, expansion joints for bridges, injectable mortars for patch and repair of cracks in structural concrete, grouting for tile, machinery rails, metal dowels, bolts, posts, electrical encapsulants, electrical panels, printed circuit boards, electrical components, wire windings, seals for electromechanical devices, battery cases, resistors, fuses, thermal cut-off devices, coatings for printed wiring boards, capacitors, transformers, electrically conductive components for antistatic applications, tennis racquets, golf club shafts, fishing rods, skis, ski poles, bicycle parts, swimming pools, swimming pool slides, hot tubs, saunas, mixers, business machine housings, trays, dishwasher parts, refrigerator parts, furniture, garage doors, gratings, protective body gear, luggage, optical waveguides, radomes, satellite dishes, signs, solar energy panels, telephone switchgear housings, transformer covers, insulation for rotating machines, commutators, core insulation, dry toner resins, bonding jigs, inspection fixtures, industrial metal forming dies, vacuum molding tools, and the like. The composition is particularly useful for fabricating printed circuit boards, encapsulating compositions, potting compounds, and composites for electrical insulation.

There is no particular limitation on techniques used to fabricate articles from the flame retarded thermoset formulations of the present invention. Processes useful for forming articles from the flame retarded thermoset formulations of the present invention include those generally known to the art for the processing of thermosetting resins. Such processes have been described in “Polyesters and Their Applications” by Bjorksten Research Laboratories, Johan Bjorksten (pres.) Henry Tovey (Ch. Lit. Ass.), Betty Harker (Ad. Ass.), James Henning (Ad. Ass.), Reinhold Publishing Corporation, New York, 1956, “Uses of Epoxy Resins”, W. G. Potter, Newnes-Buttersworth, London 1975, “Chemistry and Technology of Cyanate Ester Resins” by 1. Hamerton, Blakie Academic Publishing an Imprint of Chapman Hall. Non-limiting examples of processing techniques include casting, including for example centrifugal and static casting; contact molding, including cylindrical contact molding; compression molding; sheet molding; bulk molding; lamination including wet or dry lay up and spray lay up; resin transfer molding, including vacuum assisted resin transfer molding and chemically assisted resin transfer molding; injection molding, including reaction injection molding (RIM); atmospheric pressure molding (APM); open mold casting; Seeman's Composite Resin Infusion Manufacturing Processing (SCRIMP); pultrusion; formation into high strength composites; open molding or continuous combination of resin and glass; and filament winding, including cylindrical filament winding.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### EXAMPLES

### Example 1

Preparation of the filled polyester resin mix:

100 g of Palapreg P 17-02 from DSM Composites Resins were added with 150 g of MARTINAL® OL-104. The ATH was added in smaller portions to avoid formation of undispersed particles. During the addition of the ATH the mix was intensively stirred with a high shear mixer with dissolver disc (diameter 40 mm) for instance model CA from the company VMA Getzmann. The stirrer speed for this operation is usually 1000-2000 rpm at the beginning and 4000 rpm once the total quantity of the filler has been added. The final mixing time is three minutes at the speed of 4000 rpm. The total time to incorporate the filler and properly mix is 5-7 minutes.

After this mixing step the filled dispersion is conditioned in a water bath at 23° C. for about 4 hours to allow the mix to adopt the temperature relevant for viscosity measurement and to release trapped air.

Measurement of the viscosity:

The viscosity measurement is carried out with a viscosimeter HBDVII+ from Brookfield. Depending on the viscosity range the suitable spindle (different size) has to be selected. In this trial spindle no. 7 has been utilized. The viscosity has been measured at 23° C. and spindle speed of 10 rpm. In order to compensate for viscosity variation in the neat polyester resin the obtained viscosity values of the filled dispersions have to be corrected with a factor KFH. KFH is the quotient of a reference viscosity (1.6 Pa x s) and the viscosity of the neat resin used for the mixing trial. For this trial the factor KFH was 0.65. The final corrected viscosity is 158 Pa*s.

### Example 2

Preparation of the filled polyester resin mix:

100 g of Palapreg P 17-02 from DSM Composites Resins were added with 1.5 g of wetting additive W-996 from the company Byk followed by 150 g of MARTINAL® OL-104. The mixing process was the same as described in Example 1 as well as the conditioning step.

Measurement of the viscosity:

The viscosity was measured as described in Example 1. The final corrected viscosity is 35 Pa*s.

### Example 3

Preparation of the filled polyester resin mix:

100 g of Palapreg P 17-02 from DSM Composites Resins were added with 3.0 g of weeting additive W-996 from Byk followed by 150 g of MARTINAL® OL-104. The mixing process was the same as described in Example 1 as well as the conditioning step.

Measurement of the viscosity:

The viscosity was measured as described in Example 1. The final corrected viscosity is 27 Pa*s.

### Example 4

Preparation of the filler polyester resin mix:

100 g of Palapreg P 17-02 from DSM Composites Resins were added with 15 g of Antiblaze V 490 followed by 150 g of MARTINAL® OL-104. The mixing process was the same as described in Example 1 as well as the conditioning step.

Measurement of the viscosity:

The viscosity was measured as described in Example 1. The final corrected viscosity is 27 Pa*s.

### Example 5

Preparation of the filled polyester resin mix:

100 g of Palapreg P 17-02 from DSM Composites Resins were added with 30 g of Antiblaze V 490 followed by 150 g of MARTINAL® OL-104. The mixing process was the same as described in Example 1 as well as the conditioning step.

Measurement of the viscosity:

The viscosity was measured as described in Example 1. The final corrected viscosity is 10 Pa*s.

### Example 6

Preparation of the filled polyester resin mix:

100 g of Palapreg P 17-02 from DSM Composites Resins were added with 15 g of Antiblaze V 490, 1.5 g of Byk W-996 and 150 g of MARTINAL OL-104. The mixing process was the same as described in Example 1 as well as the conditioning step.

Measurement of the viscosity:

The viscosity was measured as described in Example 1. The final corrected viscosity is 7 Pa*s.

### Example 7

Preparation of the filled polyester resin mix:

115 g of Palapreg P 17-02 from DSM Composites Resins were added with 150 g MARTINAL® OL-104. The mixing process was the same as described in Example 1 as well as the conditioning step.

Measurement of the viscosity:

The viscosity was measured as described in Example 1. The final corrected viscosity is 57 Pa*s.

### Example 8

Preparation of the filled polyester resin mix to prepare sheets for UL 94 test:

100 g of Palapreg P 17-02 from DSM Composites Resins were added with 100 g of MARTINAL® OL-104. The mixing process was the same as described in Example 1 as well as the conditioning step.

Measurement of the viscosity:

The viscosity was measured as described in Example 1. The final corrected viscosity is 11 Pa*s.

Preparation of the sheet:

The filled polyester resin mix was added with 5 g Butanox® M-50 (peroxide) and 0.5 g NL 49 P Co catalyst (peroxide activator based on cobalt compound) using the dissolver at a speed of less than 1000 rpm to avoid heating-up/premature curing and incorporation of air. The final resin mix was poured into a metal frame with thickness of 3 mm and put in an oven at 40° C. over night. The sheet sample was then taken out of the frame and cut to 127×12.7×3 mm. This formulation did not meet any of the UL 94 ratings.

### Example 9

Preparation of the filled polyester resin mix to prepare sheets for UL 94 test:

100 g of Palapreg P 17-02 from DSM Composites Resins were added with 1 g of Byk W-996 followed by 100 g of MARTINAL® OL-104. The mixing process was the same as described in Example 1 as well as the conditioning step.

Measurement of the viscosity:

The viscosity was measured as described in Example 1. The final corrected viscosity is 8 Pa*s.

Preparation of the sheet:

The filled polyester resin mix was added with 5 g Butanox® M-50 and 0.5 g NL 49 P Co catalyst using the dissolver at a speed of less 1000 rpm to avoid heating-up/premature curing and incorporation of air. The final resin mix was poured into a metal frame with thickness of 3 mm and put in an oven at 40° C. over night. The sheet sample was then taken out of the frame and cut to 127×12.7×3 mm This formulation did not meet any of the UL 94 ratings.

### Example 10

Preparation of the filled polyester resin mix to prepare sheets for UL 94 test:

100 g of Palapreg P 17-02 from DSM Composites Resins were added with 10 g of Antiblaze® V 490 followed by 100 g of MARTINAL® OL-104. The mixing process was the same as described in Example 1 as well as the conditioning step.

Measurement of the viscosity:

The viscosity was measured as described in Example 1. The final corrected viscosity is 5 Pa*s.

Preparation of the sheet:

The filled polyester resin mix was added with 5 g Butanox® M-50 and 0.5 g NL 49 P Co catalyst using the dissolver at a speed of less than 1000 rpm to avoid heating-up/premature curing and incorporation of air. The final resin mix was poured into a metal frame with thickness of 3 mm and put in an oven at 40° C. over night. The sheet sample was then taken out of the frame and cut to 127×12.7×3 mm. This formulation had a V 0 rating in the UL 94 test.

### Example 11

Preparation of the filled polyester resin mix to prepare sheets for UL 94 test:

100 g of Palapreg P 17-02 from DSM Composites Resins were added with 20 g of Antiblaze® V 490 followed by 100 g of MARTINAL® OL-104. The mixing process was the same as described in Example 1 as well as the conditioning step.
Measurement of the viscosity:

The viscosity was measured as described in Example 1. The final corrected viscosity is 3 Pa*s.

Preparation of the sheet:

The filled polyester resin mix was added with 5 g Butanox® M-50 and 0.5 g NL 49 P Co catalyst using the dissolver at a speed of less than 1000 rpm to avoid heating-up/premature curing and incorporation of air. The final resin mix was poured into a metal frame with thickness of 3 mm and put in an oven at 40° C. over night. The sheet sample was then taken out of the frame and cut to 127×12.7×3 mm. This formulation had a V 0 rating in the UL 94 test.

### Example 12

Preparation of the filled polyester resin mix to prepare sheets for UL 94 test:

100 g of Palapreg P 17-02 from DSM Composites Resins were added with 1 g of Byk W-996, 10 g of Antiblaze® V 490 followed by 100 g of MARTINAL® OL-104. The mixing process was the same as described in Example 1 as well as the conditioning step.

Measurement of the viscosity:

The viscosity was measured as described in Example 1. The final corrected viscosity is 3 Pa*s.

Preparation of the sheet:

The filled polyester resin mix was added with 5 g Butanox® M-50 and 0.5 g NL 49 P Co catalyst using the dissolver at a speed of less 1000 rpm to avoid heating-up/premature curing and incorporation of air. The final resin mix was poured into a metal frame with thickness of 3 mm and put in an oven at 40° C. over night. The sheet sample was then taken out of the frame and cut to 127×12.7×3 mm. This formulation had a V 0 rating in the UL 94 test.

What is claimed:

1) A flame retarded thermoset derivable from: a) at least one phosphonate; b) at least one metal hydroxide; c) at least one thermoset resin; and, optionally d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

2) The flame retarded thermoset according to claim 1 wherein said at least one phosphonate is diethyl ethylphosphonate.

3) The flame retarded thermoset according to claim 1 wherein said at least one thermoset resin is selected from acrylics, urethanes, unsaturated polyesters, vinyl esters, epoxies, phenol/formaldehyde resins, urea/formaldehyde resins and melamine/formaldehyde resins; crosslinkable acrylic resins derived from substituted acrylates such as epoxy acrylates, hydroxy acrylates, isocyanato acrylates, urethane acrylates or polyester acrylates; alkyd resins, polyester resins and acrylate resins crosslinked with melamine resins, urea resins, isocyanates, isocyanurates, carbamates, epoxy resins, functionalized poly(arylene ether) resins, which may be a capped poly(arylene ether) or ring-functionalized poly(arylene ether); unsaturated polyester resins, urea resins; and natural or synthetic rubbers such as EPDM, butyl rubber, isoprene rubber, SBR, NIR, urethane rubber, polybutadiene rubber, acrylic rubber, silicone rubber, fluoro-elastomer, NBR, polymeric suspensions (latices) and chloro-sulfonated polyethylene resins. Further included are polymeric suspensions (latices).

4) The flame retarded thermoset according to claim 2 wherein the thermoset resin is an unsaturated polyester resin.

5) The flame retarded thermoset according to claim 1 wherein said at least one phosphonate is used in an amount in the range of from about 0.1 to about 25 wt. %, based on the total combined weight of a)-d).

6) The flame retarded thermoset according to claim 4 wherein said metal hydroxide has a d50 in the range of from about 0.1 to about 30.

7) The flame retarded thermoset according to claim 5 wherein said at least one metal hydroxide is used in an amount in the range of from about 75 to about 99.99 wt. %, based on the total combined weight of a), b), and d).

8) A flame retardant additive suitable for use in thermoset resins comprising: a) at least one, phosphonate; and b) at least one metal hydroxide.

9) The flame retardant additive according to claim 8 wherein said flame retardant additive further comprises one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

10) The flame retardant additive according to claim 8 wherein said flame retardant additive comprises in the range of from about 0.1 to about 25 wt. %, of said at least one phosphonate, based on the total weight of the flame retardant additive.

11) The flame retardant additive according to claim 8 wherein said flame retardant additive comprises in the range of from about 75 to about 99.99 wt. %, of said at least one metal hydroxide, based on the total weight of the flame retardant additive.

12) The flame retardant additive according to claim 8 wherein said flame retardant additive is used to provide flame retardancy to a thermoset resin.

13) The flame retardant additive according to claim 8 wherein said flame retardant additive is used in an amount in the range of from about 80 to about 500 phr.

14) A flame retarded thermoset formulation comprising: a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

15) The flame retarded thermoset formulation according to claim 14 wherein the thermoset resin is an unsaturated polyester resin.

16) The flame retarded thermoset formulation according to claim 14 wherein said at least one phosphonate is used in an amount in the range of from about 0.1 to about 25 wt. %, based on the total combined weight of a), b), and d).

17) The flame retarded thermoset formulation according to claim 16 wherein said metal hydroxide has a d50 in the range of from about 0.1 to about 30.

18) The flame retarded thermoset formulation according to claim 17 wherein said at least one metal hydroxide is used in an amount in the range of from about 40 to about 85 wt. %, based on the total combined weight of a)-d).

19) The flame retarded thermoset formulation according to claim 14, wherein said flame retarded thermoset formulation has a viscosity, as determined by using a Brookfield viscometer, in the range of from about 1 to about 150 Pa*s.

20) A cured composition obtained by curing a flame retarded thermoset formulation comprising: a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof any of the thermoset formulations of the present invention.

21) A cured composition, comprising the reaction product obtained or obtainable by curing a flame retarded thermoset formulation comprising: a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof.

22) An article made or produced from a flame retarded thermoset formulation comprising: a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof any of the thermoset formulations of the present invention.

23) The article according to claim 22 wherein said article is any one or more of: acid bath containers, neutralization tanks, electrorefining tanks, water softener tanks, fuel tanks, filament-wound tanks, filament-wound tank linings, electrolytic cells, exhaust stacks, scrubbers, automotive exterior panels, automotive floor pans, automotive air scoops, truck bed liners, drive shafts, drive shaft couplings, tractor parts, transverse leaf springs, crankcase heaters, heat shields, railroad tank cars, hopper car covers, boat hulls, submarine hulls, boat decks, marine terminal fenders, aircraft components, propeller blades, missile components, rocket motor cases, wing sections, sucker rods, fuselage sections, wing skins, wing flairings, engine narcelles, cargo doors, aircraft stretch block and hammer forms, bridge beams, bridge deckings, stair cases, railings, walkways, pipes, ducts, fan housings, tiles, building panels, scrubbing towers, flooring, expansion joints for bridges, injectable mortars for patch and repair of cracks in structural concrete, grouting for tile, machinery rails, metal dowels, bolts, posts, electrical encapsulants, electrical panels, printed circuit boards, electrical components, wire windings, seals for electromechanical devices, battery cases, resistors, fuses, thermal cut-off devices, coatings for printed wiring boards, capacitors, transformers, electrically conductive components for antistatic applications, tennis racquets, golf club shafts, fishing rods, skis, ski poles, bicycle parts, swimming pools, swimming pool slides, hot tubs, saunas, mixers, business machine housings, trays, dishwasher parts, refrigerator parts, furniture, garage doors, gratings, protective body gear, luggage, optical waveguides, radomes, satellite dishes, signs, solar energy panels, telephone switchgear housings, transformer covers, insulation for rotating machines, commutators, core insulation, dry toner resins, bonding jigs, inspection fixtures, industrial metal forming dies, vacuum molding tools, and the like.

24) The article according to claim 22 wherein said article is one or more of: printed circuit boards, encapsulating compositions, potting compounds, and composites for electrical insulation.

25) A process for forming a flame retarded thermoset comprising combining a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing promoters; photoinitiators; blowing agents, rhelogical modifiers; impact modifiers; mold release aids; nucleating agents; the like, and combinations thereof, in the presence of at least one curing catalyst.

26) The process according to claim 25 wherein, before curing, said flame retarded thermoset has a viscosity, as determined by using a Brookfield viscometer, in the range of from about 1 to about 150 Pa*s.

27) An article obtainable by combining a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing promoters; photoinitiators; blowing agents, rhelogical modifiers; impact modifiers; mold release aids; nucleating agents; the like, and combinations thereof, in the presence of at least one curing catalyst.

28) The article according to claim 27 wherein said article is any one or more of: acid bath containers, neutralization tanks, electrorefining tanks, water softener tanks, fuel tanks, filament-wound tanks, filament-wound tank linings, electrolytic cells, exhaust stacks, scrubbers, automotive exterior panels, automotive floor pans, automotive air scoops, truck bed liners, drive shafts, drive shaft couplings, tractor parts, transverse leaf springs, crankcase heaters, heat shields, railroad tank cars, hopper car covers, boat hulls, submarine hulls, boat decks, marine terminal fenders, aircraft components, propeller blades, missile components, rocket motor cases, wing sections, sucker rods, fuselage sections, wing skins, wing flairings, engine narcelles, cargo doors, aircraft stretch block and hammer forms, bridge beams, bridge deckings, stair cases, railings, walkways, pipes, ducts, fan housings, tiles, building panels, scrubbing towers, flooring, expansion joints for bridges, injectable mortars for patch and repair of cracks in structural concrete, grouting for tile, machinery rails, metal dowels, bolts, posts, electrical encapsulants, electrical panels, printed circuit boards, electrical components, wire windings, seals for electromechanical devices, battery cases, resistors, fuses, thermal cut-off devices, coatings for printed wiring boards, capacitors, transformers, electrically conductive components for antistatic applications, tennis racquets, golf club shafts, fishing rods, skis, ski poles, bicycle parts, swimming pools, swimming pool slides, hot tubs, saunas, mixers, business machine housings, trays, dishwasher parts, refrigerator parts, furniture, garage doors, gratings, protective body gear, luggage, optical waveguides, radomes, satellite dishes, signs, solar energy panels, telephone switchgear housings, transformer covers, insulation for rotating machines, commutators, core insulation, dry toner resins, bonding jigs, inspection fixtures, industrial metal forming dies, vacuum molding tools, and the like.

29) An uncured thermoset composition comprising: a) at least one phosphonate; b) at least one metal hydroxide; c) at least one thermoset resin; and, optionally, d) one or more additives selected from dyes; pigments; colorants; antioxidants; stabilizers; plasticizers; lubricants; flow modifiers or aids; additional flame retardants; drip retardants; antiblocking agents; antistatic agents; flow-promoting agents; processing aids; UV stabilizers; PVC resins; matting agents; adhesion promoters; electrically conductive agents; multivalent metal ion; curing initiators or catalyst; curing promoters; photoinitiators; blowing agents, rhelogical modifiers; impact modifiers; mold release aids; nucleating agents; the like, and combinations thereof. Any of the thermoset formulations of the present invention.

30) The process according to claim 29 wherein said uncured thermoset composition has a viscosity, as determined by using a Brookfield viscometer, in the range of from about 1 to about 150 Pa*s.
